(19) United States
(12) Patent Application Publication
(10) Pub. No.: US 2024/0416858 A1
(43) Pub. Date: Dec. 19, 2024

(54) VEHICLE GRILLE STRUCTURE

(71) Applicant: Honda Motor Co., Ltd., Tokyo (JP)

(72) Inventors: Hisakazu HANAOKA, Saitama (JP); Ryu HIROOKA, Saitama (JP); Takao ISHIKAWA, Saitama (JP); Takanori KONISHI, Tokyo (JP); Takuto YANAGITA, Tokyo To (JP); Ayumi ONO, Tokyo To (JP); Yuu Kikuchi, Tochigi (JP)

(73) Assignee: Honda Motor Co., Ltd., Tokyo (JP)

(21) Appl. No.: 18/745,980

(22) Filed: Jun. 17, 2024

(30) Foreign Application Priority Data
Jun. 19, 2023 (CN) 202310726904.1

(51) Int. Cl. B60R 19/52

(52) U.S. Cl. CPC B60R 19/52

(57) ABSTRACT

The disclosure provides a vehicle grille structure that is capable of suppressing wind noise and taking into account appearance. The vehicle grille structure includes: a vehicle exterior member, having a grille opening; a grille fin, provided on the grille opening and across the grille opening in an up and down direction of the vehicle; and a reinforcement rib, provided on a rear surface of the grille fin and having a size in a width direction of the vehicle that is smaller than a size of the grille fin in the width direction. The reinforcement rib extends in the up and down direction and is inclined in the width direction.

### CROSS-REFERENCE TO RELATED APPLICATION

This application claims the priority benefit of China application serial no. 202310726904.1, filed on Jun. 19, 2023. The entirety of the above-mentioned patent application is hereby incorporated by reference herein and made a part of this specification.

### TECHNICAL FIELD

The disclosure relates to a vehicle structure, and more particularly to a vehicle grille structure.

### DESCRIPTION OF RELATED ART

In conventional technologies, a vehicle grille structure includes a vehicle exterior member (e.g., a bumper) having a grille opening and a grille fin provided on the grille opening and extending along the up and down direction. The grille fin is usually made by molding, so that the rear side of the grille fin has a partition line corresponding to the joint surface of the mold, and a stepped portion is formed on the rear side of the partition line to help demolding. In this way, when the vehicle is traveling, the airflow flowing through the vehicle forms a whirlpool near the stepped portion on the rear side of the grille fin. Since the whirlpool is continuously generated along the partition line and grows in this state, wind noise is generated. In this regard, a common way to improve this is to set the partition line of the grille fin to offset in the up and down direction, for example, to set the partition line to be inclined in the up and down direction, or to set the partition line in a concave and convex structure to adjust the position/size of the stepped portion, etc., so that the length of the grille fin in the front and rear direction are not equal in all areas in the up and down direction, thereby suppressing the wind noise. However, such an improvement method causes the partition line or the stepped portion of the grille fin to be easily seen from outside of the vehicle, and it becomes inclined when viewed laterally, resulting in a poor appearance of the vehicle grille structure. Thus, it is necessary to improve the wind noise and appearance of the vehicle grille structure.

### SUMMARY

The disclosure provides a vehicle grille structure that is capable of suppressing wind noise and taking into account appearance.

The disclosure provides a vehicle grille structure, including: a vehicle exterior member, having a grille opening; a grille fin, provided on the grille opening and across the grille opening in an up and down direction of the vehicle; and a reinforcement rib, provided on a rear surface of the grille fin and having a size in a width direction of the vehicle that is smaller than a size of the grille fin in the width direction. The reinforcement rib extends in the up and down direction and is inclined in the width direction.

Based on the above, in the vehicle grille structure of the disclosure, the reinforcement rib is provided on the rear surface of the grille fin and has a size in the width direction of the vehicle that is smaller than a size of the grille fin in the width direction. Moreover, the reinforcement rib extends in the up and down direction and is inclined in the width direction. In this way, the reinforcement rib suppresses the whirlpool generated on the rear side of the grille fin, thereby reducing wind noise, and the reinforcement rib is less visible from outside of the vehicle, ensuring the appearance of the vehicle grille structure. Accordingly, the vehicle grille structure of the disclosure may suppress wind noise while maintaining good appearance.

In order to make the aforementioned features and advantages of the disclosure comprehensible, embodiments accompanied with drawings are described in detail below.

### BRIEF DESCRIPTION OF THE DRAWINGS

FIG. 1 is a perspective schematic view of the vehicle grille structure according to an embodiment of the disclosure.

FIG. 2 is a partially enlarged schematic view of the vehicle grille structure shown in FIG. 1 near the grille fin.

FIG. 3 is a schematic view of the rear side of the vehicle grille structure shown in FIG. 2.

FIG. 4 is a cross-sectional schematic view of the vehicle grille structure shown in FIG. 3 cut along the profile line A-A′.

FIG. 5 is a cross-sectional schematic view of the vehicle grille structure shown in FIG. 3 cut along the profile line B-B′.

FIG. 6 is a cross-sectional schematic view of the vehicle grille structure shown in FIG. 3 cut along the profile line C-C′.

### DESCRIPTION OF THE EMBODIMENTS

In one embodiment of the disclosure, a size of the reinforcement rib in a front and rear direction of the vehicle is one third or less of a size of the grille fin in the front and rear direction.

In one embodiment of the disclosure, a size of the reinforcement rib in the front and rear direction of the vehicle is equal in all areas in the up and down direction.

In one embodiment of the disclosure, the reinforcement rib extends from an upper end portion of the grille fin to a lower end portion of the grille fin in the up and down direction and extends from one end portion of left and right end portions of the grille fin to other end portion of the left and right end portions in the width direction.

In one embodiment of the disclosure, a stepped portion is provided between each left and right sides of the reinforcement rib in the width direction and the rear surface of the grille fin, a size of the stepped portion on one side of the reinforcement rib in the width direction gradually becomes larger along the up and down direction, and a size of the stepped portion on other side of the reinforcement rib in the width direction gradually becomes smaller along the up and down direction.

In one embodiment of the disclosure, a size of the grille fin in the front and rear direction of the vehicle is equal in all areas in the up and down direction.

In one embodiment of the disclosure, a size of the reinforcement rib in the width direction is equal in entire area in the up and down direction, and a size of the grille fin in the width direction is equal in entire area in the up and down direction.

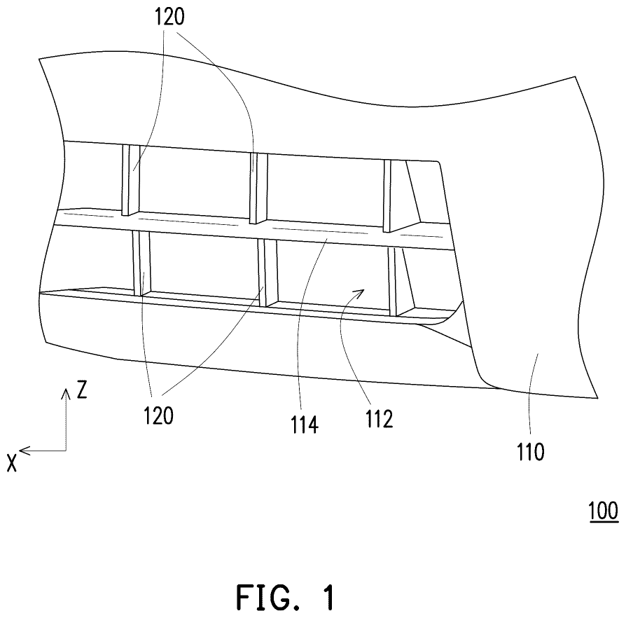

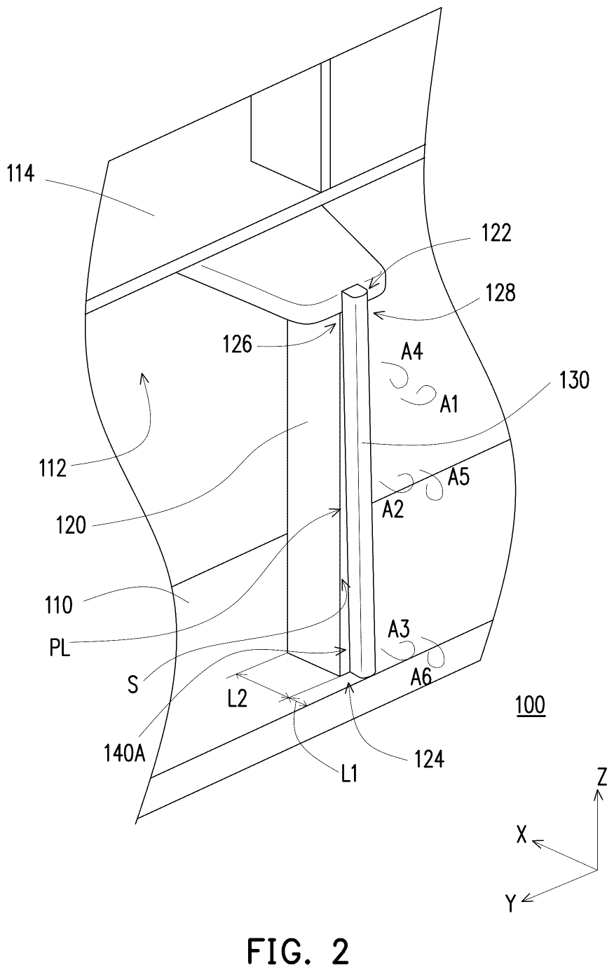

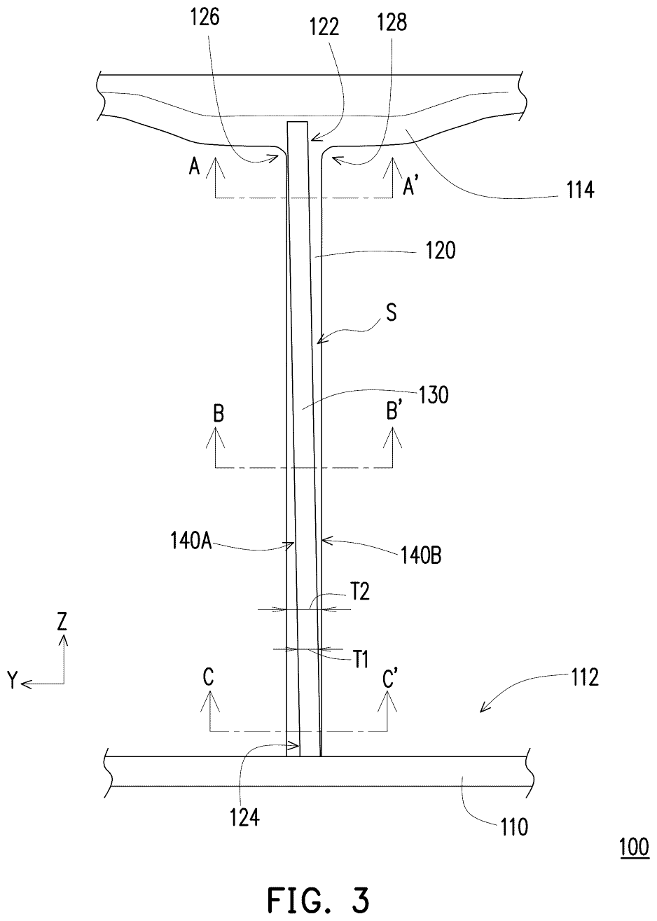

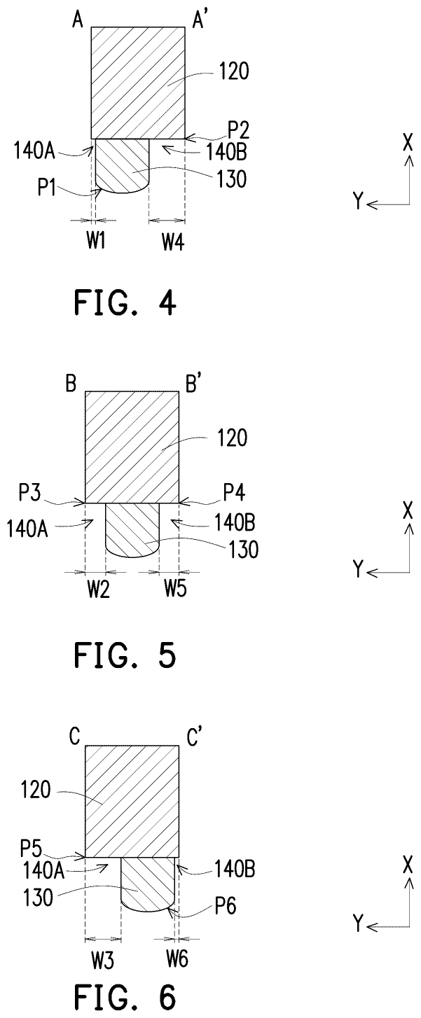

FIG. 1 is a perspective schematic view of the vehicle grille structure according to an embodiment of the disclosure. FIG. 2 is a partially enlarged schematic view of the vehicle grille structure shown in FIG. 1 near the grille fin. FIG. 3 is a schematic view of the rear side of the vehicle grille structure shown in FIG. 2. FIG. 4 is a cross-sectional schematic view of the vehicle grille structure shown in FIG. 3 cut along the profile line A-A′. FIG. 5 is a cross-sectional schematic view of the vehicle grille structure shown in FIG. 3 cut along the profile line B-B′. FIG. 6 is a cross-sectional schematic view of the vehicle grille structure shown in FIG. 3 cut along the profile line C-C′. The specific configuration of the vehicle grille structure 100 of this embodiment are described below with reference to FIG. 1 to FIG. 6, where the front and rear direction of the vehicle is, for example, the front and rear direction X in the drawings and the direction indicated by the arrow is the front; the width direction of the vehicle is, for example, the width direction Y in the drawings and the direction indicated by the arrow is the left; and the up and down direction of the vehicle is, for example, the up and down direction Z in the drawings and the direction indicated by the arrow is the top. However, these are only some examples of the disclosure, and the disclosure is not limited thereto.

Referring to FIG. 1 to FIG. 3, in this embodiment, the vehicle grille structure 100 is adapted to be installed on the front end side (i.e., the side corresponding to the front side in the front and rear direction X) of the vehicle (not shown). The vehicle grille structure 100 includes a vehicle exterior member 110, a grille fin 120, and a reinforcement rib 130. The vehicle exterior member 110 has a grille opening 112. As an example, the vehicle exterior member 110 is a bumper provided on the front side of the vehicle (i.e., the direction indicated by the arrow of the front and rear direction X), but it is not limited thereto. In addition, the grille fin 120 is provided on the grille opening 112 and across the grille opening 112 in the up and down direction Z of the vehicle. The reinforcement rib 130 is provided on a rear surface S of the grille fin 120 (i.e., the surface corresponding to the rear side in the front and rear direction X) and has a size in the width direction Y of the vehicle (i.e., thickness T1) that is smaller than a size of the grille fin 120 in the width direction Y (i.e., thickness T2). Moreover, the reinforcement rib 130 extends in the up and down direction Z and is inclined in the width direction Y. However, the specific structure and the application of the vehicle grille structure 100 is not limited by the disclosure and may be adjusted according to needs.

Specifically, in this embodiment, as shown in FIG. 1, the grille opening 112 of the vehicle exterior member 110 is opened toward the front side and connects the inner and outer sides of the vehicle (i.e., the front and rear sides), and the grille opening 112 extends in the front and rear direction X and the width direction Y to form an arc-shaped long opening (FIG. 1 shows the lateral portion). Correspondingly, the grille fin 120 is formed into a thin sheet structure extending in the up and down direction Z and across the grille opening 112 in the up and down direction Z. The grille fin 120 may extend from the upper end portion to the lower end portion of the grille opening 112, or a horizontal separator 114 extending in the width direction Y may be provided on the center of the grille opening 112, and the grille fin 120 may extend from the upper end portion of the grille opening 112 to the horizontal separator 114 or from the horizontal separator 114 to the lower end portion of the grille opening 112. In addition, the vehicle grille structure 100 may also be provided with multiple grille fins 120 along the extending direction of the grille opening 112, for example, two rows of grille fins 120 are provided on the upper and lower sides of the horizontal separator 114. In addition, although the grille fin 120 is provided along the up and down direction Z, it is not limited to parallel to the up and down direction Z, it may be provided slightly inclined with respect to the up and down direction Z. The disclosure does not limit the shape and amount of grille fin 120, which may be adjusted according to needs.

Furthermore, in this embodiment, as shown in FIG. 2 and FIG. 3, the reinforcement rib 130 is formed into a thin sheet structure extending in the up and down direction Z, and is set on the rear surface S of the grille fin 120. In other words, the reinforcement rib 130 may be regarded as a reinforcement structure protruding from the rear surface S of the grille fin 120 toward the rear side. The reinforcement rib 130 has a size in the width direction Y (i.e., thickness T1) that is smaller than a size of the grille fin 120 in the width direction Y (i.e., thickness T2). That is, the reinforcement rib 130 is formed into a thin sheet structure thinner than the grille fin 120 in the width direction Y. As an example, a size of the reinforcement rib 130 in the width direction Y (i.e., thickness T1) is equal in entire area in the up and down direction, and a size of the grille fin 120 in the width direction Y (i.e., thickness T2) is equal in entire area in the up and down direction. The reinforcement rib 130 is formed into a thin sheet structure thinner than the grille fin 120 in the entire area in the up and down direction, but is not limited thereto. In addition, the reinforcement rib 130 extends in the up and down direction Z and is inclined in the width direction Y. That is, the reinforcement rib 130 is provided so as to be inclined with respect to the grille fin 120 in the width direction Y. In the case that the vehicle grille structure 100 is provided with multiple grille fins 120 along the extending direction of the grille opening 112, the vehicle grille structure 100 may also provide multiple reinforcement ribs 130 correspondingly, that is, each rear surface S of the grille fin 120 is provided with one reinforcement rib 130 correspondingly. However, in other embodiments not shown, the reinforcement rib 130 may be provided on only one or some of the rear surface S of the grille fins 120. The disclosure does not limit the shape and amount of reinforcement rib 130, which may be adjusted according to needs.

It may be seen that in this embodiment, the reinforcement rib 130 protrudes toward the rear side from the rear surface S of the grille fin 120, and the thickness T1 of the reinforcement rib 130 in the width direction Y is smaller than the thickness T2 of the grille fin 120 in the width direction Y. In this way, the reinforcement rib 130 is less visible from outside of the vehicle (i.e., from the front side of the grille opening 112), and the appearance of the vehicle grille structure 100 may be secured. In addition, the reinforcement rib 130, which has a smaller thickness, does not completely cover the rear surface S of the grille fin 120, so when the vehicle is traveling, the airflow flowing through the vehicle generates a whirlpool near the rear surface S of the grille fin 120 and near the reinforcement rib 130. At this time, since the reinforcement rib 130 extends in the up and down direction Z and is inclined in the width direction Y, that is, the reinforcement rib 130 is gradually offset from one side to the other side in the width direction Y along the up and down direction Z, so that the reinforcement rib 130 may disrupt the airflow near the rear surface S of the grille fin 120. In this way, the reinforcement rib 130 may suppress the whirlpool generated on the rear side of the grille fin 120, thereby reducing wind noise. Accordingly, the vehicle grille structure 100 may suppress wind noise while maintaining good appearance.

Furthermore, in this embodiment, as shown in FIG. 2 and FIG. 3, the reinforcement rib 130 extends from an upper end portion 122 of the grille fin 120 to a lower end portion 124 of the grille fin 120 in the up and down direction Z and extends from one end portion of left and right end portions of the grille fin 120 (e.g., the left end portion 126) to other end portion of the left and right end portions (e.g., the right end portion 128) in the width direction Y. That is, the reinforcement rib 130 extends obliquely from the upper left to the lower right, and the reinforcement rib 130 is formed on the entire area of the rear surface S of the grille fin 120 in the up and down direction Z (i.e., the size of the reinforcement rib 130 in the up and down direction Z is larger than the size of the grille fin 120 in the up and down direction Z). In this way, stepped portions 140A and 140B are provided between each left and right sides of the reinforcement rib 130 in the width direction Y and the rear surface S of the grille fin 120. However, the reinforcement rib 130 may also extends obliquely from the upper right to the lower left and may be formed on one of the areas of the rear surface S of the grille fin 120 in the up and down direction Z (i.e., the size of the reinforcement rib 130 in the up and down direction Z is smaller than the size of the grille fin 120 in the up and down direction Z). However, the disclosure is not limited thereto, and it may be adjusted according to needs.

As an example, as shown in FIG. 4 to FIG. 6, the size of the stepped portion 140A on one side (e.g., the left side) of the reinforcement rib 130 in the width direction Y gradually becomes larger from top to bottom along the up and down direction Z (e.g., widths W1, W2, and W3 gradually becomes larger), and the size of the stepped portion 140B on the other side (e.g., the right side) of the reinforcement rib 130 in the width direction Y gradually becomes smaller from top to bottom along the up and down direction Z (e.g., widths W4, W5, and W6 gradually becomes smaller). That is, the shapes of the stepped portions 140A and 140B formed on the left and right sides of the reinforcement rib 130 in the width direction Y are substantially opposite in the up and down direction Z (as shown in FIG. 3). In this way, in the horizontal height shown in FIG. 4, the left side airflow takes the left side end point P1 of the reinforcement rib 130 as a peeling point (i.e., the position where the airflow leaves after flowing along the surface), and the right side airflow takes the right side end point P2 of the grille fin 120 as the peeling point. Moreover, in the horizontal height shown in FIG. 5, the left side airflow takes the left side end point P3 of the grille fin 120 as a peeling point, and the right side airflow takes the right side end point P4 of the grille fin 120 as the peeling point. Correspondingly, in the horizontal height shown in FIG. 6, the left side airflow takes the left side end point P5 of the grille fin 120 as a peeling point, and the right side airflow takes the right side end point P6 of the reinforcement rib 130 as the peeling point.

It may be seen that in this embodiment, the peeling point of the left side airflow changes from the left side end point P1 closer to the rear side to the left side end point P5 closer to the front side along the up and down direction Z, so that the whirlpools A1, A2, and A3 formed by the left side airflow in the up and down direction Z gradually approach the front side from top to bottom, as shown in FIG. 2. Correspondingly, the peeling point of the right side airflow changes from the right side end point P2 closer to the front side to the right side end point P6 closer to the rear side along the up and down direction Z, so that the whirlpools A4, A5, and A6 formed by the right side airflow in the up and down direction Z gradually approach the rear side from top to bottom, as shown in FIG. 2. In this way, the airflow is unevenly distributed up and down due to the interference of the inclined reinforcement rib 130. Similarly, the peeling points of the left side airflow and the right side airflow at the same height are offset in the front and rear direction X, for example, in FIG. 4, the left side end point P1 on the same horizontal height is closer to the rear side than the right side end point P2, so that in FIG. 2, the whirlpool A1 on the same horizontal height is closer to the rear side than the whirlpool A4. In this way, the airflow is unevenly distributed left and right due to the interference of the inclined reinforcement rib 130. This may further suppress the formation of the whirlpool. In addition, when the grille fin 120 and the reinforcement rib 130 are manufactured by molding, the edge of the rear surface S of the grille fin 120 is configured as a partition line PL corresponding to the joint surface of the mold, and the stepped portions 140A and 140B formed behind the partition line PL may be used to assist demolding. However, the disclosure does not limit the grille fin 120 and the reinforcement rib 130 to be made integrally, they may also be made separately and then combined and may be adjusted according to needs.

In addition, in this embodiment, as shown in FIG. 2 and FIG. 3, a size of the reinforcement rib 130 in the front and rear direction X of the vehicle (i.e., length L1) is one third or less of a size of the grille fin 120 in the front and rear direction X (i.e., length L2). That is, the reinforcement rib 130 is formed into a thin sheet structure with a short length. In this way, even if the grille fin 120 is provided along the arc-shaped grille opening 112 and slightly offset with respect to the front and rear direction X at the side portion of the vehicle exterior member 110, the reinforcement rib 130 provided on the rear surface S of the grille fin 120 is difficult to see from outside of the vehicle (i.e., from the front side of the grille opening 112). In addition, preferably, a size of the reinforcement rib 130 in the front and rear direction X of the vehicle (i.e., length L1) is equal in all areas in the up and down direction Z. That is, the reinforcement rib 130 is formed into a thin sheet structure with equal length along the up and down direction Z. In this way, the reinforcement rib 130 does not form a concave-convex structure or an inclined surface that is visually visible, so that the reinforcement rib 130 is more difficult to see from outside of the vehicle (i.e., from the front side of the grille opening 112). Similarly, preferably, a size of the grille fin 120 in the front and rear direction X of the vehicle (i.e., length L2) is equal in all areas in the up and down direction Z. That is, the grille fin 120 is formed into a thin sheet structure with equal length along the up and down direction Z. In this way, since the grille fin 120 has the same length in all areas in the up and down direction Z and does not form a concave-convex structure or an inclined surface that is visually visible, the vehicle grille structure 100 has a good appearance because it is not inclined when viewed laterally as in the non-uniform length structures of conventional technology. However, the specific structures of the grille fin 120 and the reinforcement rib 130 are not limited by the disclosure and may be adjusted according to needs.

To sum up, in the vehicle grille structure of the disclosure, the reinforcement rib is provided on the rear surface of the grille fin and has a size in the width direction of the vehicle that is smaller than a size of the grille fin in the width direction. Moreover, the reinforcement rib extends in the up and down direction and is inclined in the width direction. In this way, the reinforcement rib suppresses the whirlpool generated on the rear side of the grille fin, thereby reducing wind noise, and the reinforcement rib is less visible from outside of the vehicle, ensuring the appearance of the vehicle grille structure. Preferably, the size of the reinforcement rib in the front and rear direction is equal in all areas in the up and down direction, and the size of the reinforcement rib in the front and rear direction is one third or less of the size of the grille fin in the front and rear direction, so the reinforcement rib is difficult to see from the outside of the vehicle. Accordingly, the vehicle grille structure of the disclosure may suppress wind noise while maintaining good appearance.

Finally, it should be noted that the foregoing embodiments are only used to illustrate the technical solutions of the disclosure, but not to limit the disclosure; although the disclosure has been described in detail with reference to the foregoing embodiments, persons of ordinary skill in the art should understand that the technical solutions described in the foregoing embodiments can still be modified, or parts or all of the technical features thereof can be equivalently replaced; however, these modifications or substitutions do not deviate the essence of the corresponding technical solutions from the scope of the technical solutions of the embodiments of the disclosure.

What is claimed is:

1. A vehicle grille structure, comprising:
a vehicle exterior member, having a grille opening;
a grille fin, provided on the grille opening and across the grille opening in an up and down direction of the vehicle; and
a reinforcement rib, provided on a rear surface of the grille fin and having a size in a width direction of the vehicle that is smaller than a size of the grille fin in the width direction, wherein
the reinforcement rib extends in the up and down direction and is inclined in the width direction.

2. The vehicle grille structure according to claim 1, wherein
a size of the reinforcement rib in a front and rear direction of the vehicle is one third or less of a size of the grille fin in the front and rear direction.

3. The vehicle grille structure according to claim 1, wherein
a size of the reinforcement rib in a front and rear direction of the vehicle is equal in all areas in the up and down direction.

4. The vehicle grille structure according to claim 1, wherein
the reinforcement rib extends from an upper end portion of the grille fin to a lower end portion of the grille fin in the up and down direction and extends from one end portion of left and right end portions of the grille fin to other end portion of the left and right end portions in the width direction.

5. The vehicle grille structure according to claim 1, wherein
a stepped portion is provided between each left and right sides of the reinforcement rib in the width direction and the rear surface of the grille fin,
a size of the stepped portion on one side of the reinforcement rib in the width direction gradually becomes larger along the up and down direction, and
a size of the stepped portion on other side of the reinforcement rib in the width direction gradually becomes smaller along the up and down direction.

6. The vehicle grille structure according to claim 2, wherein
a stepped portion is provided between each left and right sides of the reinforcement rib in the width direction and the rear surface of the grille fin,
a size of the stepped portion on one side of the reinforcement rib in the width direction gradually becomes larger along the up and down direction, and
a size of the stepped portion on other side of the reinforcement rib in the width direction gradually becomes smaller along the up and down direction.

7. The vehicle grille structure according to claim 3, wherein
a stepped portion is provided between each left and right sides of the reinforcement rib in the width direction and the rear surface of the grille fin,
a size of the stepped portion on one side of the reinforcement rib in the width direction gradually becomes larger along the up and down direction, and
a size of the stepped portion on other side of the reinforcement rib in the width direction gradually becomes smaller along the up and down direction.

8. The vehicle grille structure according to claim 4, wherein
a stepped portion is provided between each left and right sides of the reinforcement rib in the width direction and the rear surface of the grille fin,
a size of the stepped portion on one side of the reinforcement rib in the width direction gradually becomes larger along the up and down direction, and
a size of the stepped portion on other side of the reinforcement rib in the width direction gradually becomes smaller along the up and down direction.

9. The vehicle grille structure according to claim 1, wherein
a size of the grille fin in a front and rear direction of the vehicle is equal in all areas in the up and down direction.

10. The vehicle grille structure according to claim 2, wherein
a size of the grille fin in a front and rear direction of the vehicle is equal in all areas in the up and down direction.

11. The vehicle grille structure according to claim 3, wherein
a size of the grille fin in a front and rear direction of the vehicle is equal in all areas in the up and down direction.

12. The vehicle grille structure according to claim 4, wherein
a size of the grille fin in a front and rear direction of the vehicle is equal in all areas in the up and down direction.

13. The vehicle grille structure according to claim 1, wherein
a size of the reinforcement rib in the width direction is equal in entire area in the up and down direction, and a size of the grille fin in the width direction is equal in entire area in the up and down direction.

14. The vehicle grille structure according to claim 2, wherein
a size of the reinforcement rib in the width direction is equal in entire area in the up and down direction, and a size of the grille fin in the width direction is equal in entire area in the up and down direction.

15. The vehicle grille structure according to claim 3, wherein
a size of the reinforcement rib in the width direction is equal in entire area in the up and down direction, and a size of the grille fin in the width direction is equal in entire area in the up and down direction.

16. The vehicle grille structure according to claim 4, wherein
a size of the reinforcement rib in the width direction is equal in entire area in the up and down direction, and a size of the grille fin in the width direction is equal in entire area in the up and down direction.
